(19) United States
(12) Patent Application Publication
(10) Pub. No.: US 2010/0104370 A1
(43) Pub. Date: Apr. 29, 2010

(54) Inner Pipe Fixation Device

(75) Inventor: Jan van Egmond, Fillin (NL)

Correspondence Address: HOFFMANN & BARON, LLP, 6900 JERICHO TURNPIKE, SYOSSET, NY, 11791, US

(73) Assignee: HEEREMA MARINE CONTRACTORS NEDERLAND B.V., Leiden (NL)

(21) Appl. No.: 12/444,293

(22) PCT Filed: Oct. 4, 2006
(86) PCT No.: PCT/NL06/00501

§ 371 Date: Apr. 3, 2009

(51) Int. Cl. F16L 1/12; B63B 35/03

(52) U.S. Cl. 405/156; 405/154.1

(57) ABSTRACT

The present invention relates to a fixation device for fixation of a position of an inner pipe of a double-walled pipe with respect to a pipe laying structure and/or an outer pipe of said double-walled pipe, said fixation device comprising: an inner pipe gripping device (23) configured to grip said inner pipe, and a connection device (24,25,2S) configured to connect said inner pipe gripping device with said pipe laying structure and/or said outer pipe, said connection device having a flexible state in which, during use, the inner pipe gripping device is movable with respect to said pipe laying structure and/or said outer pipe, and a fixation state in which, during use, the inner pipe gripping device is fixated with respect to the pipe-laying structure and/or said outer pipe.

### CROSS-REFERENCE TO RELATED APPLICATIONS

This application is the National Stage of International Application No. PCT/NL2006/000501, filed Oct. 4, 2006, the contents of which is incorporated by reference herein.

### FIELD OF THE INVENTION

The present invention relates to a fixation device configured to fixate a position of an inner pipe of a double-walled pipe with respect to an outer pipe of said double-walled pipe. Furthermore, the invention relates to a fixation device to fixate a position of an inner pipe of a double walled pipe with respect to a pipe-laying structure during the welding of a new inner pipe section to an inner pipe of an existing pipeline.

### BACKGROUND

In the offshore industry there is a need for underwater pipelines. These underwater pipelines may be provided by joining pipe sections together in a substantially vertical position to form a pipeline which is lowered from a vessel to an underwater bottom, for instance the bottom of the sea. In such pipe laying method, which is commonly referred to as a J-lay method a plurality of pipe sections welded to one another, together forming a part of the pipeline, hang down from a vessel in a substantially vertical direction, where an upper end of the most recently joined pipe section is to be welded to a lower end of a new pipe section being lined up above said upper end.

In a specific embodiment of the J-lay method, at least one end of the pipe sections is provided with a collar for easier handling of the pipe sections. Upon completion of a weld, the end of the pipeline is gripped by the collar with a clamping device and lowered to just below the welding position to prepare for a new pipe section to be arranged above the upper end of the lowered pipeline.

For some applications it is desirable to provide double walled pipelines, i.e. so-called pipe in pipe pipelines. Such double walled pipeline comprises at least an outer pipe and an inner pipe being arranged concentrically in said outer pipe. The inner pipe may in the axial direction be supported by bulkheads connecting the inner pipe to the outer pipe at regular intervals, or any other suitable connection means between the inner pipe and the outer pipe. The presence of the outer pipe may for instance prevent the inner pipe from buckling laterally. Also the space between the outer pipe and the inner pipe may serve as an insulation layer.

When laying a double-walled pipeline using a J-lay tower, the existing pipeline is held at the upper end of the outer pipe. As a result, due to motions of the pipe laying vessel on the sea surface, and oscillating motion is induced into the outer pipe. The double-walled pipe may respond as a mass-spring system, wherein the oscillating motion is transferred from the outer pipe via the connection between the outer pipe and the inner pipe, for instance a bulkhead, to the inner pipe. As a consequence, there may be a relative motion between the upper end of the outer pipe and the upper end of the inner pipe.

When a new inner pipe section is to be welded to the inner pipe of the existing pipeline, the relative motion between the outer pipe of the existing pipeline held by a clamping device and the upper end of the inner pipe may lead to difficulties in positioning the lower end of the new inner pipe section with respect to the upper end of the inner pipe of the existing pipeline, since the line-up device for the new inner pipe section is not capable of following the movements of the existing inner pipe.

Moreover, even when these movements could be followed the welding of the new inner pipe section to the inner pipe of the existing pipeline would imply difficulties since also the welding equipment should be able to follow accurately the movements of the inner pipe and inner pipe section to make welding possible.

On the other hand it is not possible to simply clamp the inner pipe to fixate the inner pipe, since the inner pipe could be fixated at a position of at a motion speed of said inner pipe which would induce huge forces in the fixation device or in the inner pipe. These forces may be large enough to damage the inner pipe and/or the fixation device.

It has been proposed to stabilize the relative motion between the inner pipe and the outer pipe by filling the space between the inner pipe and the outer pipe with a friction material. However, the provision of such material takes a considerable amount of time and the insulation properties of the double walled pipe may decrease due to the presence of the material between the inner and outer pipe. In alternative embodiments it has been proposed to provide wedges between the inner pipe and outer pipe for fixation of the inner pipe, but this method has also led to unsatisfactory results.

### SUMMARY OF THE INVENTION

It is desirable to provide a fixation device for fixation of an inner pipe of a double-walled pipe with respect to a pipe laying structure and/or an outer pipe of said double-walled pipe, which fixation device allows relatively easy an quick fixation of said inner pipe in a certain position or position range in order to make proper welding of a new inner pipe section on the inner pipe of an existing pipeline, in particular in a J-lay tower, possible.

In an embodiment the present invention provides a fixation device for fixation of a position of an inner pipe of a double-walled pipe with respect to a pipe laying structure and/or an outer pipe of said double-walled pipe, said fixation device comprising:
an inner pipe gripping device configured to grip said inner pipe, and
a connection device configured to connect said inner pipe gripping device with said pipe laying structure and/or said outer pipe, said connection device having a flexible state in which, during use, the inner pipe gripping device is movable with respect to said pipe laying structure and/or said outer pipe, and a fixation state in which, during use, the inner pipe gripping device is fixated with respect to the pipe-laying structure and/or said outer pipe.

The fixation device of the invention allows the inner pipe to be gripped, for instance clamped, without it being directly fixated. As a result the inner pipe may after gripping still move with respect to the pipe-laying structure/outer pipe since the connection device allows such movements when being in the flexible state. However, when the inner pipe is in a desired position, the connection device may be transferred from the flexible state to the fixation state. The connection device does not allow any movement of said inner pipe with respect to the pipe laying structure or outer pipe to which the connection device is connected. As a result the inner pipe will not move with respect to the pipe laying structure and the new inner pipe section can be welded on the inner pipe of the existing pipe line.

Since the transfer from the flexible state to the fixation state can be performed relatively quickly the position and/or the motion speed at which the inner pipe will be fixated can be predicted accurately and/or at a motion speed at which no huge forces will be induced in the fixation device or in the inner pipe.

The fixation device may be configured to fixate the inner pipe with respect to the pipe laying structure or with respect to the outer pipe. As normally the pipe laying structure holds the outer pipe of the existing pipeline at least during welding in a fixed position, the inner pipe will in both embodiments be fixated with respect to both the pipe laying structure and the outer pipe.

In an embodiment, the connection device is connected to an outer pipe gripping device configured to grip said outer pipe. In such embodiment the inner pipe is fixated with respect to the outer pipe. In a preferred embodiment the outer pipe gripping device is configured to confine a collar provided on or nearby an upper end of the outer pipe of the existing pipeline, as such collar provides suitable bearing surfaces in the axial direction to limit the axial movement of the outer pipe gripping device with respect to the outer pipe without the need for a clamping device with a large clamping force. Such collars are often provided at or nearby the upper end of the existing pipeline to support the pipeline on a hang off table.

In an embodiment of the invention the connection device comprises one or more hydraulic piston-cylinder assemblies. Hydraulic piston cylinder assemblies are very suitable to serve as a connection device having a flexible state and a fixation state. For instance, the piston-cylinder assembly comprises a first and a second working fluid space in said cylinder at opposite sides of said piston, which first and second working fluid spaces are in fluid communication with each other during the flexible state and are closed with respect to each other during the fixation state. By providing a valve in the fluid communication line between the first and the second working fluid space the transfer between the flexible state and the fixation state may be performed by opening and closing of the valve.

The determination whether the inner pipe has reached the desired position for fixation may be done visually by an operator. However, it is preferred that a sensor device is provided which sensor device is configured to determine the position of said inner pipe with respect to said pipe laying structure an/or said outer pipe. With such sensor device the position of the inner pipe may be determined with high accuracy and the behavior of the inner pipe can be followed more easily. Furthermore, the risk on human errors is reduced.

In an embodiment the invention provides a method to fixate an inner pipe of a double-walled pipe with respect to the outer pipe thereof, said method comprising the steps of:
gripping said outer pipe with an outer pipe gripping device,
determining the position of said inner pipe with respect to said outer pipe,
gripping said inner pipe with an inner pipe gripping device, said inner pipe gripping device being connected with said outer pipe gripping device via a connection device, said connection device having a flexible state in which movement between the inner pipe gripping device and the outer pipe is possible and a fixation state in which the inner pipe gripping device is fixated with respect to said outer pipe, said connection device being in the flexible state, and
fixating said inner pipe with respect to said outer pipe by bringing the connection device in the fixation state.

In an embodiment the invention provides a method to fixate an inner pipe of a double-walled pipe with respect to a pipe laying structure, said method comprising the steps of:
determining the position of said inner pipe with respect to said pipe laying structure,
gripping said inner pipe with an inner pipe gripping device, said inner pipe gripping device being connected with said pipe laying structure via a connection device, said connection device having a flexible state in which movement between the inner pipe gripping device and the pipe laying structure is possible and a fixation state in which the inner pipe gripping device is fixated with respect to the pipe laying structure, said connection device being in the flexible state,
and
fixating said inner pipe with respect to said pipe laying structure by bringing the connection device in the fixation state.

### SHORT DESCRIPTION OF THE DRAWINGS

The invention will now be described in more detail whereby reference is made to the appended drawings, in which:

FIG. 1 shows a prior art pipe laying vessel comprising a J-lay tower for laying a double walled pipeline;

FIG. 2 shows a mass-spring system to explain the dynamic behavior of the double-walled pipe;

FIG. 3 shows the prior art pipe laying vessel of FIG. 1 just before welding a new inner pipe section to the inner pipe of the existing pipeline;

FIG. 4 shows a cross section of an embodiment of a fixation device according to the invention;

FIG. 5 shows a top view of the outer pipe gripping device of the embodiment of FIG. 4 in an opened position;

FIG. 6 shows a top view of the outer pipe gripping device of the embodiment of FIG. 4 in a closed position;

FIG. 7 shows a top view of an alternative embodiment of an outer pipe gripping device according to the invention in an almost closed position;

FIG. 8 shows a top view of the inner pipe gripping device of the embodiment of FIG. 4 in an opened position;

FIG. 9 shows a top view of the inner pipe gripping device of the embodiment of FIG. 4 in a closed position;

FIG. 10 shows a cross section of the fixation device of FIG. 4 in an almost closed position of the inner pipe gripping device;

FIG. 11 shows a schematic graph of the relative motion between inner pipe and outer pipe before fixation of the inner pipe;

FIG. 12 shows a cross section of the fixation device of FIG. 4 in a closed position of the inner pipe gripping device; and

FIG. 13 shows a piston-cylinder assembly of FIG. 12 in more detail.

FIGS. 14a-f show an alternative embodiment of a hydraulic system a piston-cylinder assembly according to the invention.

### DETAILED DESCRIPTION OF A PREFERRED EMBODIMENT

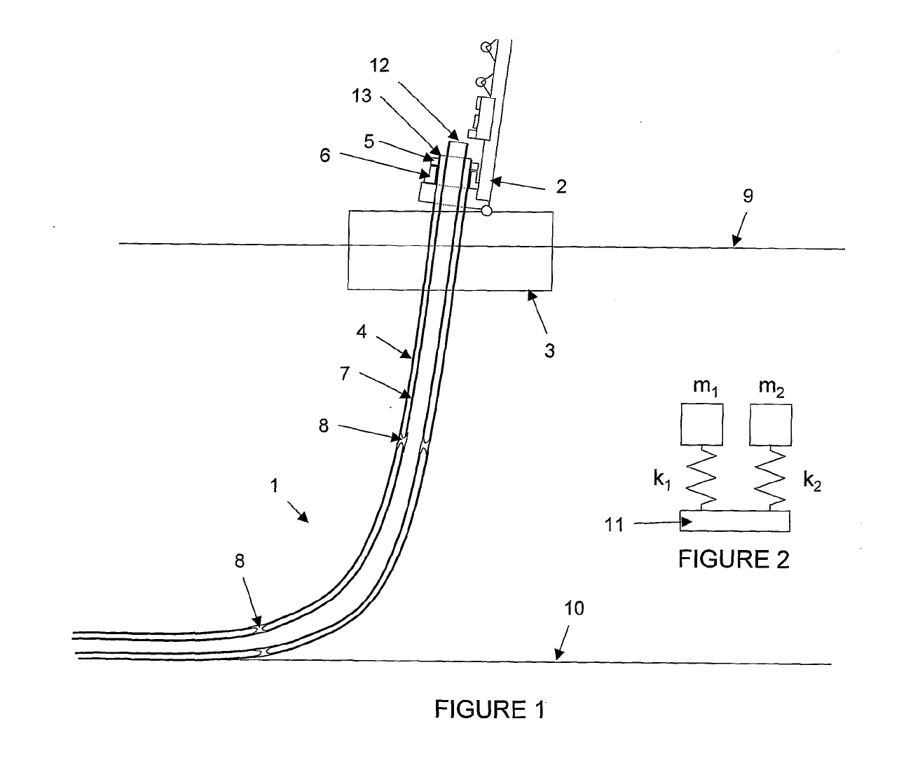

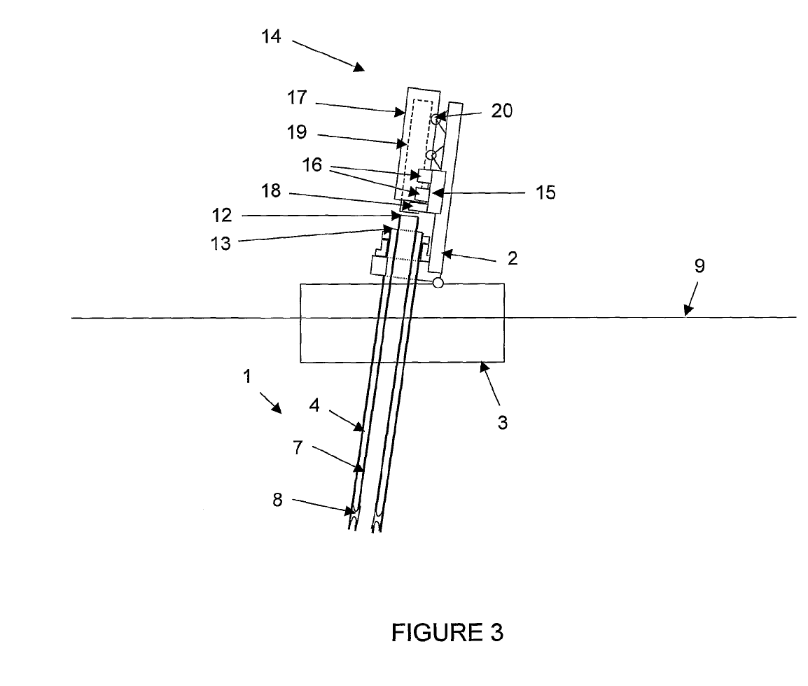

FIG. 1 shows a pipe laying vessel 3 comprising a J-lay tower for laying double walled pipelines 1 to a sea bed 10. Such double-walled pipeline generally comprises an outer pipe 4 and an inner pipe 7.

When laying a double walled (pipe-in-pipe) pipeline 1 to a seabed 10 by means of a J-Lay Tower 2 mounted on a pipelaying vessel 3, the outer pipe 4 is hung off from a collar 5 welded to the outer pipe 4, the collar 5 resting on a hang-off table 6 which is axially rigidly supported by the J-Lay Tower 2. Alternatively, the outer pipe may be held by a tensioner device rigidly connected to the J-Lay Tower 2 or by any other suitable device known in the art.

The inner pipe 7 is in axial direction supported by bulkheads 8 connecting the inner pipe 7 to the outer pipe 4 at substantially regular intervals. As an alternative, any other suitable connection between the outer pipe 4 and the inner pipe 7 may be used.

Due to motions of the pipelaying vessel 3 on the sea surface 9, an oscillating motion may be induced via the hang-off table 6 and the collar 5 into the outer pipe 4. The outer pipe 4 responds as the mass-spring system (m1, k1) represented in FIG. 2, transferring the oscillation motion to the connecting element 11 over time. The connecting element 11 in the model reflects either the first bulkhead 8 below the collar 5 or friction between the outer pipe 4 and the inner pipe 7 in the zone between the collar 5 and the first bulkhead 8 there below. The connecting element 11 now transfers its motion over time to the second mass-spring system (m2, k2) representing the inner pipe 4. As a result of this behavior, a relative motion is induced between the upper end 12 of the inner pipe and the upper end 13 of the outer pipe.

The relative motion between the upper end 12 of the inner pipe and the upper end 13 of the outer pipe may provide a problem for welding a next pipe section 14 to the pipeline 1. The pipe section 14 is gripped by an external line-up tool 15 with outer pipe holding device 16 holding the outer pipe section 17 and an inner pipe holding device 18 for holding the inner pipe section 19. The upper end of pipe section 14 is supported by tower rollers 20. The external line-up tool 15 is rigidly connected to the J-Lay Tower 2. For welding the pipe section 14 to the pipeline 1, first the inner pipe section 19 is slid downwards by the inner pipe holding device 18 and lined up with the top end 12 of the inner pipe 7. After the weld between the inner pipe sections has been finished, the outer pipe section 17 is slid down over the inner pipe section 19 by means of the outer pipe holding device 16 and lined up with the upper end 13 of the outer pipe 4.

The inner pipe holding device 18 and the outer pipe holding device 16 thus have the capability of moving the inner and outer pipe sections 17 and 19 axially and laterally. However, inner pipe holding device 18 can not move the inner pipe section 19 quick enough to follow the relative motion of the top end 12 of the inner pipe 7 with respect to the top end 13 of the outer pipe and thus with respect to the collar 5, the hang-off table 6, the J-lay Tower 2 and the external line-up tool 15 which are all rigidly connected in the axial direction of the pipeline 1.

It has been proposed to stabilize the relative motion of the inner pipe 7 with respect to the outer pipe 4 by filling the annulus between both pipes with an isolating and hardening material which generated so much friction that relative motions are prohibited. However, this procedure is time consuming and the insulating properties of the hardening material are worse than the insulating properties of air, the pipeline has been designed for.

Also it has been proposed to stabilize the inner pipe with respect to the outer pipe by means of wedges. However, this procedure is cumbersome, as huge forces can develop in particular when the inner and outer pipe are relatively stiff and the distance between the top end 12 of the inner pipe 7 and the first bulkhead 8 there below is large.

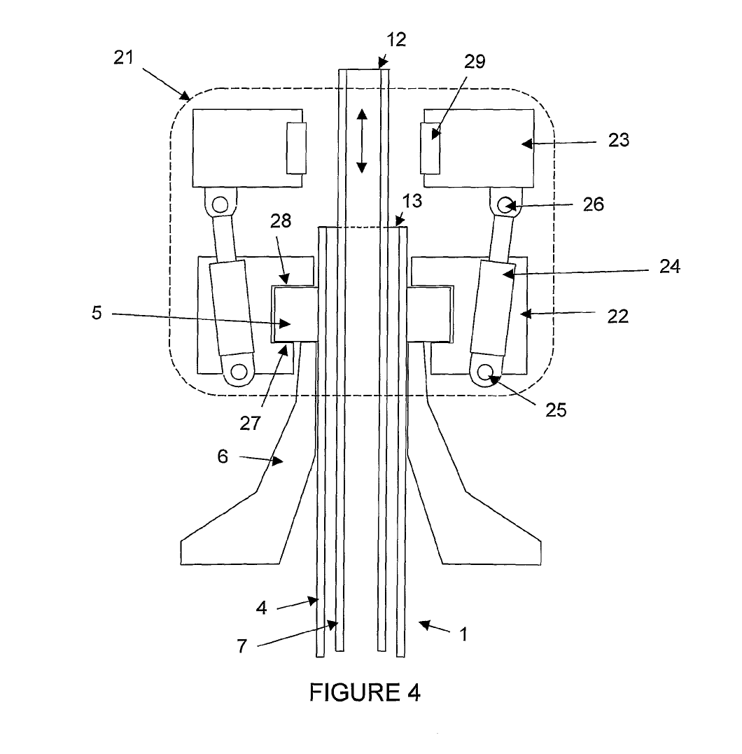

FIG. 4 shows an embodiment of an fixation device according to the present invention generally indicated with the reference numeral 21.

The inner pipe fixation device 21 comprises an outer pipe gripping device 22 and an inner pipe gripping device 23, and a connection device comprising a number of hydraulic jacks 24, i.e. piston-cylinder assemblies, connecting the outer pipe gripping device 22 and the inner pipe gripping device 23. Each hydraulic jack 24 is connected to the outer pipe gripping device 22 by means of a hinge 25 and to the inner pipe gripping device 23 by means of a hinge 26. The hinges 25 and 26 allow the inner pipe gripping device 23 to be opened and closed around the upper end of the inner pipe 7. The hydraulic jacks 24 allow the inner pipe gripping device 23 to move at least in axial direction of the pipeline 1 relative to the outer pipe gripping device 22.

The outer pipe gripping device 22 is built up in a number of sections which can be moved in radial direction towards the outer pipe 4. The outer pipe gripping device 22 is engaged with the upper end of the outer pipe 4 by engagement with a collar 5 at the upper end of the outer pipe 4. When engaged with a collar 5, the outer pipe gripping device 22 is provided with an upward bearing plane 27 engaging with the underside of the collar 5 and a downward bearing plane 28 engaging with the upper side of the collar 5. The upward bearing plane 27 is capable of transferring upward forces in the axial direction of the pipeline 1 from the outer pipe gripping device 22 into the outer pipe 4 via the collar 5. The downward bearing plane 28 is capable of transferring downward forces in the axial direction of the pipeline 1 from the outer pipe gripping device 22 into the outer pipe 4 via the collar 5.

In an alternative embodiment the outer pipe gripping device 22 may be engaged to the upper end of the outer pipe 4 by a clamping device capable of transferring axial forces by means of friction.

The inner pipe gripping device 23 is built up in a number of sections which can be moved radially towards the inner pipe 7. The inner pipe gripping device 23 is engaged with the upper end of the inner pipe 7 by exerting a radial force on a set of friction elements 29 capable of transferring upward and downward forces in the axial direction of the pipeline 1 from the inner pipe 7 into the inner pipe gripping device 23.

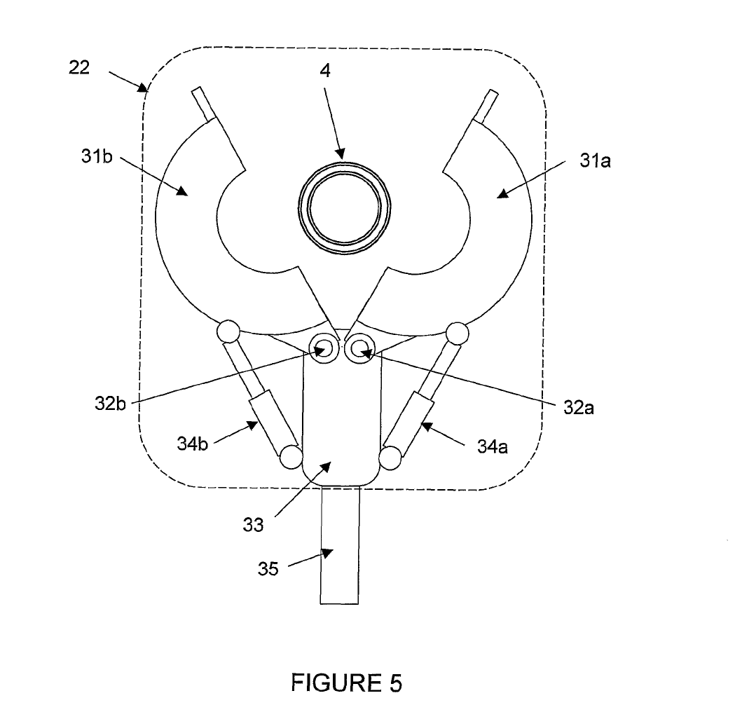

FIG. 5 shows the outer pipe gripping device 22 in more detail. The outer pipe gripping device 22 is an arrangement of two hingeable sections 31a, 31b connected to a support frame 33 by means of hinges 32a, 32b. The hinges 32a, 32b allow the hingeable sections 31a, 31b to be moved radially towards the upper end of the outer pipe 4. The hingeable sections 31a, 31b can be moved manually or by means of actuators 34a, 34b. The outer pipe gripping device 22 can be moved to and from the upper end of the outer pipe 4 in different ways, e.g. manually or by means of a crane or by means of a manipulator arm 35.

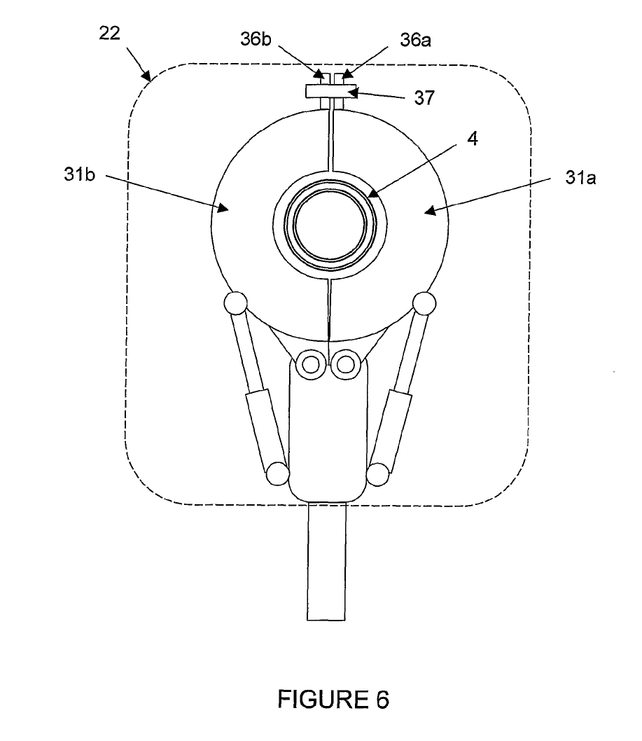

The outer pipe gripping device 22 is a collar clamping device. After closure of the hingeable sections 31a, 31b of the outer pipe gripping device 22 around the upper end of the outer pipe 4, the hingeable sections may be locked, for instance by means of two flanges 36a, 36b and securing pins or bolts 37 as shown in FIG. 6.

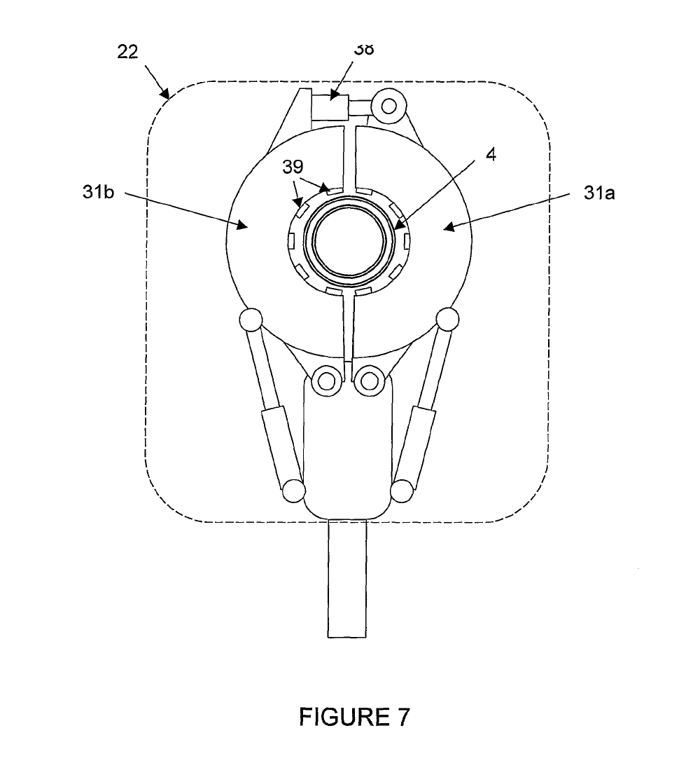

FIG. 7 shows an alternative embodiment of an outer pipe gripping device, wherein the outer pipe gripping device 22 is carried out as a friction clamping device. In this embodiment both hingeable sections 31a, 31b are pulled together with force using an actuator 38. Friction pads 39 are generating a high friction force between the outer pipe gripping device 22 and the outer pipe 4 when both hingeable sections 31a, 31b are pulled together with force around the outer pipe 4.

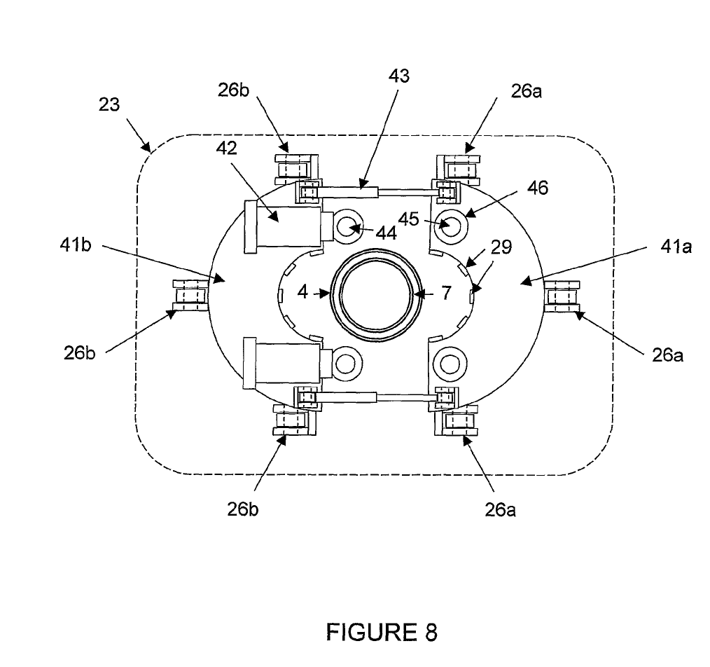

FIG. 8 shows the inner pipe gripping device 23 of the fixation device shown in FIG. 4 in more detail. The inner pipe gripping device 23 is ring shaped and comprises two half semi-ring shaped bodies 41a, 41b which can be translated in lateral direction to and from the pipeline 1. Lateral movement is ensured by hinging the inner pipe gripping device 23 over a number of equally long hydraulic jacks 24 placed between the inner pipe gripping device 23 and the outer pipe gripping device 22. Preferably three hydraulic jacks 24 are used per half body 41a, 41b.

In alternative embodiment, the inner pipe gripping device 23 is ring-shaped and may comprises two or more bodies which can be translated or rotated laterally to and from the pipeline 1.

The inner pipe gripping device 23 is preferably carried out as a friction clamp, engaging the upper end of the inner pipe 7 with friction elements 29. The inner pipe 7 is continuously in an oscillating motion and the forces to be transferred via the friction elements 29 can be high. The high forces require high capacity actuators. The continuous oscillating motion requires that the inner pipe gripping device 23 can be quickly engaged with the upper end of the inner pipe 7, when the motion of the inner pipe 7 is nearly zero. Both requirements ask for huge engagement actuators 42 with a short stroke.

When the inner pipe fixation device 21 is brought around the pipeline 1, the opening between the two half bodies 41a, 41b is much wider than the stroke of the huge engagement actuators 42. Therefore, separate small closing actuators 43 are provided between the two half bodies 41a, 41b. At one end these closing actuators are detachably connected to one of the half bodies 41a or 41b, in order to allow the inner pipe fixation device 21 to be hingeably opened and closed around the pipeline 1. The closing actuators 43 are used for pulling the two half bodies 41a, 41b so close together that the eyes 44 of the short stroke huge engagement actuators 42 on the one half body 41b can be engaged with the eyes 45 of the supports 46 on the other half body 41b.

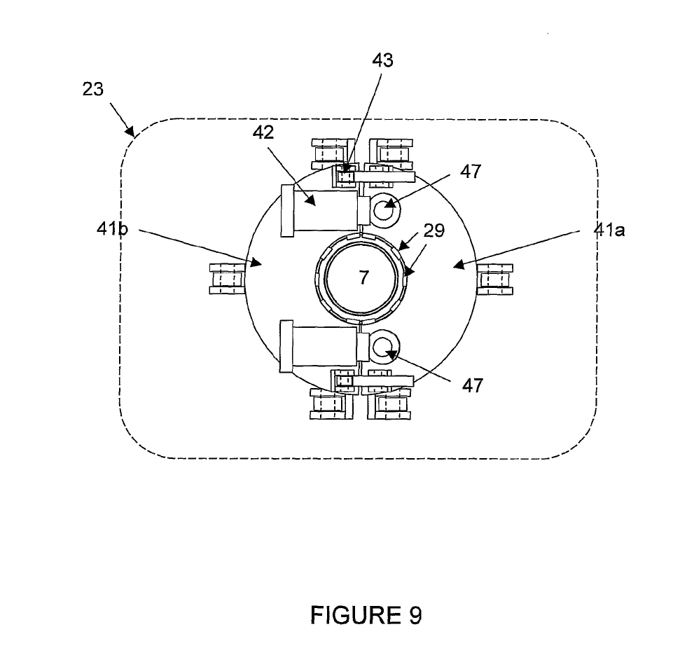

Once the eyes 44 and 45 are engaged, securing pins 47 are brought through the eyes. The huge engagement actuators 42 can now be used for the quick and forcible engagement of the inner pipe gripping device 23 with the upper end of the inner pipe 7. In FIG. 9, the inner pipe gripping device 23 is shown in the (almost) closed position.

When the inner pipe gripping device 23 has been closed by the small closing actuators 43 and the eyes 44 and 45 are engaged and secured with securing pin 47, the proper moment must be determined for activating the huge engagement actuators 42 in order to engage the friction elements 29 with the upper end of the inner pipe 7.

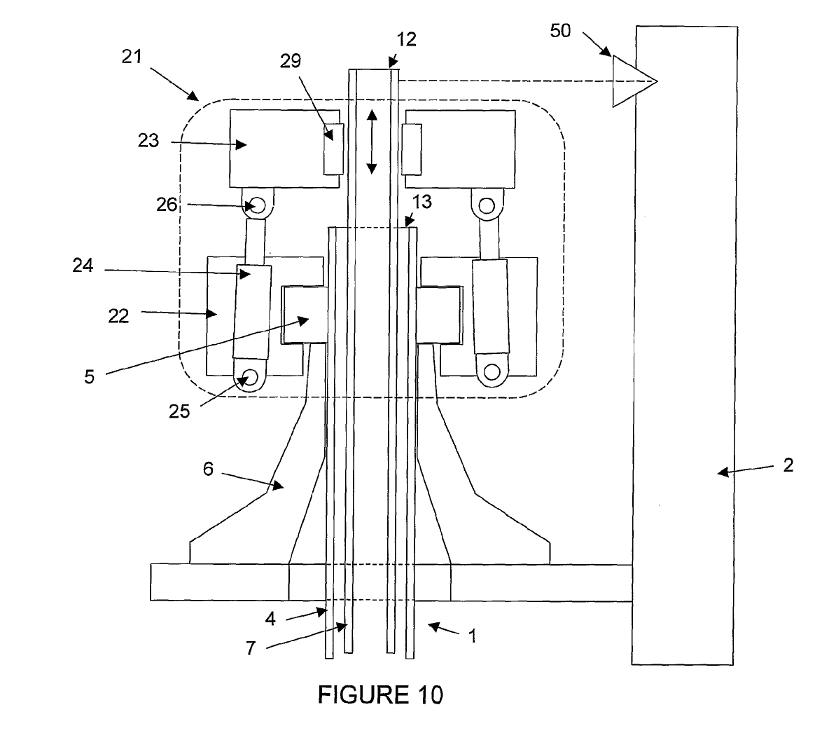

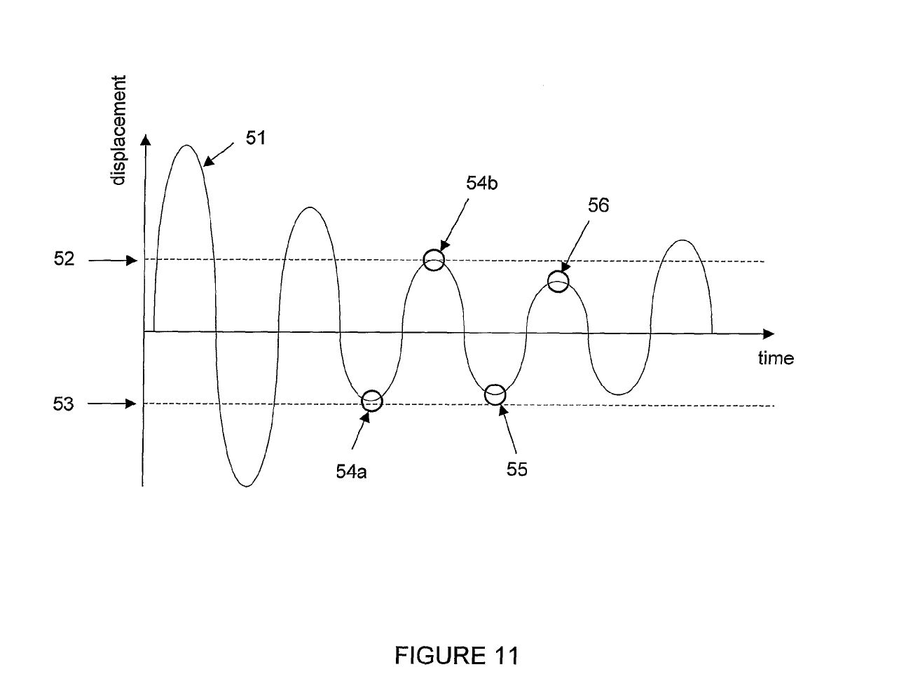

A measuring sensor 50 as shown in FIG. 10 is mounted to the J-Lay Tower 2 for measuring the motion of the upper end of the inner pipe 7 relative to the J-Lay Tower 2. As the upper end of the outer pipe 4 is fixedly connected to the J-lay Tower 2 in the axial direction of the pipeline 1 via the collar 5 and the hang-off table 6, the relative motion between the upper end of the inner pipe 7 and the J-Lay Tower is the same as the relative motion between the upper end of the inner pipe 7 and the upper end of the outer pipe 4.

Any suitable type of measuring sensor may be used to measure the position of the inner pipe. The sensor may also be mounted at any location from which such measurement can be made, for instance on the outer pipe gripping device 22.

The graph of FIG. 11 shows the relative displacement of the upper end of the inner pipe 4 relative to the upper end of the outer pipe 7 as measured by the sensor 50. The displacement shows an oscillating motion 51 with variable amplitude over time. The displacement 52 represents the upper operational limit of the hydraulic jacks 24; the displacement 53 represents the lower operational limit of the hydraulic jacks 24.

An automatic detection system may monitor when the oscillating motion 51 comes within the operational range 52, 53 of the hydraulic jacks 24. Once the maximum displacements 54a, 54b of the oscillating motion 51 have been confirmed to be within the operational range 52, 53 of the hydraulic jacks, the huge engagement actuators 42 are activated at the next downward displacement 55 of the upper end of the inner pipe 7 relative to the upper end of the outer pipe 4, the huge engagement actuators 42 engaging the friction elements 29 with the upper end of the inner pipe 7.

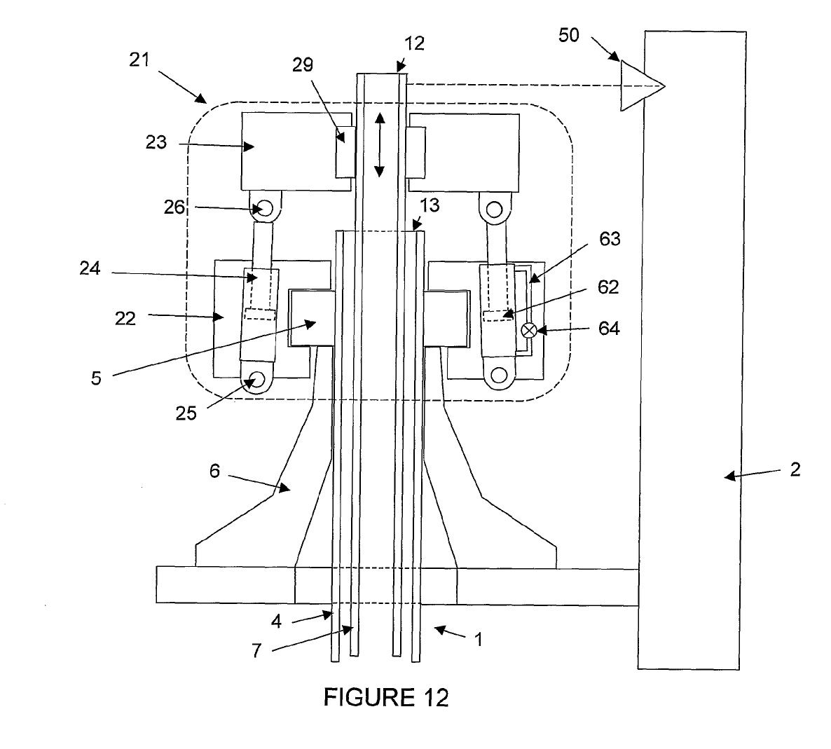

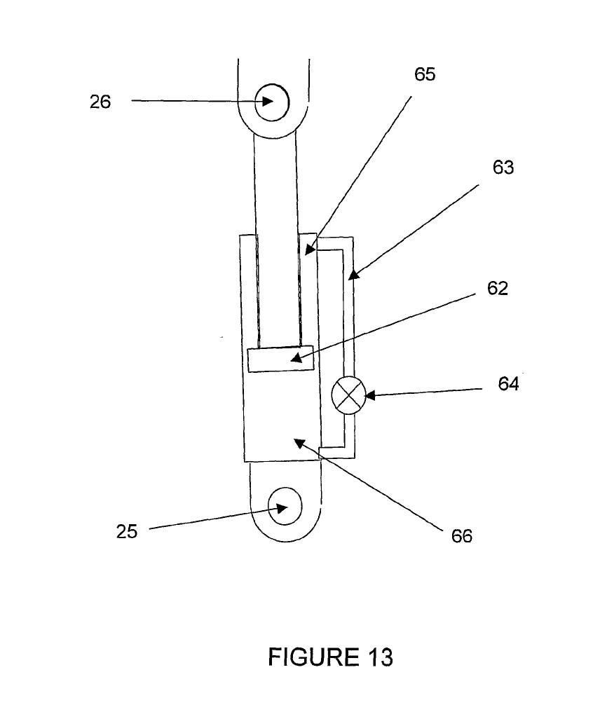

In FIG. 12 and FIG. 13 is shown that a duct 63 with a valve 64 is provided at the hydraulic jacks 24, between the oil working space 65 volume above the piston 62 and the oil working space 66 below the piston 62. When the valve 64 is open, oil is free to flow through the duct 63 around the piston 62, allowing the hydraulic jack to be pushed in and out with a relatively small force. When the valve 64 is closed, the oil flow around the piston 62 is blocked, allowing the hydraulic jacks 64 to carry a high force.

During engagement of the friction elements 29 with the upper end of the inner pipe 7, the valve 64 is open. Once the friction elements 29 have been engaged, the inner pipe gripping device 23 moves up with the upper end of the inner pipe 7. The oscillating motion of the inner pipe gripping device 23 causes the oil to flow from the upper side of the piston 62 to the underside without developing much force in the hydraulic jacks 24.

At the moment the measuring sensor 50 measures that the upper end of the inner pipe 7 is in an upper displacement position 56 within the operational range 52, 53 of the hydraulic jacks 24 and that the velocity of the oscillating motion 51 is zero, the valve 64 is closed, blocking the hydraulic jacks 24 and thus blocking the relative motion between the upper end of the inner pipe 7 relative to the upper end of the outer pipe 4. The forces initially driving the relative motion between the upper ends of the inner pipe 7 and the outer pipe 4 are now taken by the hydraulic jacks 24. The hydraulic jacks 24 can carry both downward and upward forces.

After the upper end 12 of the inner pipe 7 has been fixated relative to the J-Lay Tower 2, the next pipe section 14 can be lined up with the pipeline 1 and welded.

When the measuring sensor 50 measures the upper displacement position 56 to be outside the upper operational limit 52 of the hydraulic jacks 24, an emergency procedure is foreseen, to open the valve 64 again and if necessary disengage the inner pipe gripping device 23 by means of the huge actuators 42.

In the above described embodiment the connection device comprising the jacks 24 is connected to the outer pipe via a outer pipe gripping device 22. In an alternative embodiment the connection device may directly or indirectly be connected to the J-lay tower 2 or any other part of the pipe laying structure.

Furthermore, the outer pipe gripping device 22 and the inner pipe gripping device 23 may have a different design than described herein above.

Also the connection device may comprise any other means being transferable between a flexible state in which movement of the inner pipe gripping device in at least axial direction of the pipeline is possible and a fixation state in which such movement is prevented.

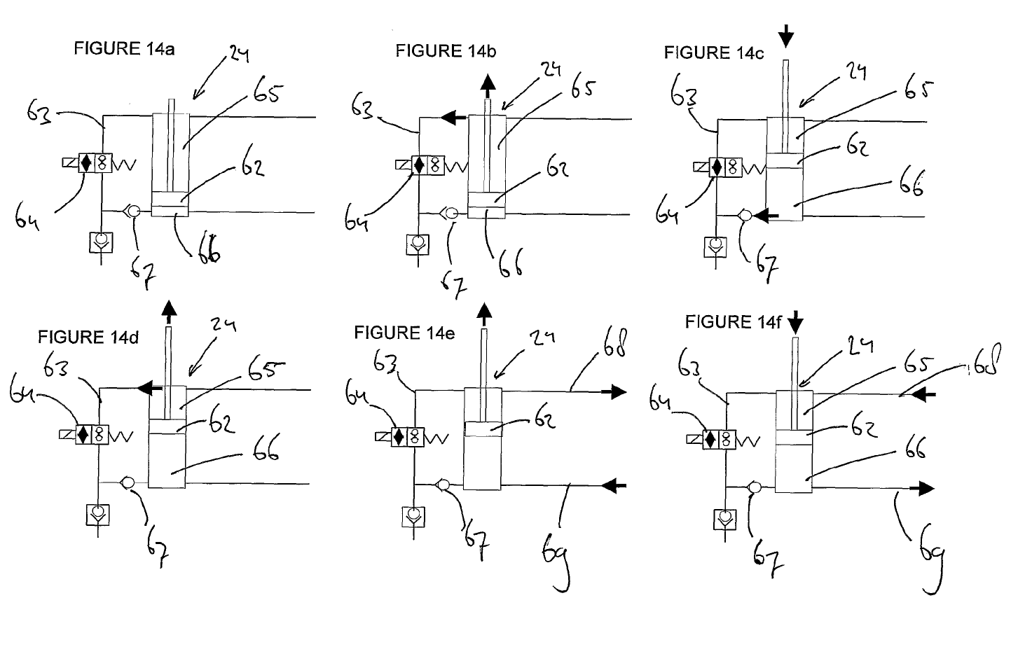

FIGS. 14a-14f show an alternative embodiment of the hydraulic system of the jacks 24 in a number of possible positions during use, respectively.

In FIG. 14a the rest position of the hydraulic system is shown. In this position the valve 64 is closed.

Before gripping an inner pipe with the inner pipe gripping device, the valve is opened as is shown in FIG. 14b, whereby the fixation device is brought from the fixation state to the flexible state so that working fluid, such as hydraulic fluid, is free to flow from the working fluid space 65 to the working fluid space 66. Flow of hydraulic fluid in the opposite direction is in this alternative embodiment however not possible due to the presence of the non-return valve 67. Such non-return valve has the following advantage.

When the inner pipe is for instance gripped by the inner pipe gripping device in a bottom position of the inner pipe (see point 55 in FIG. 11), the piston 62 will start an upward stroke and hydraulic fluid will flow out of the working fluid space 65 and into the working fluid space 66, as is shown in FIG. 14b.

When consequently the inner pipe reaches the top of the upward movement (point 56 in FIG. 11), the piston 62 will start to move downward again. However, this movement of the piston 62 will instantly be stopped since the non-return valve 67 will not allow any hydraulic fluid to flow out of the working fluid space 66 (see FIG. 14c). The inner pipe is thus fixated with respect to the outer pipe at least in the downward direction at the moment that the motion speed of the inner pipe is zero. Thus due to the presence of the non-return valve a very accurate timing of the change from the flexible state to the fixation state is obtained.

Nevertheless due to the inertia of the inner pipe and the outer pipe oscillating forces may still travel through these pipes. Therefore, the valve 64 is preferably closed before the inner pipe would start a new upward movement. When the valve 64 is closed, the inner pipe is fixated in both directions as is shown in FIG. 14d. The actuation of the valve 64, is preferably carried out directly after the piston 62 has reached its highest point (point 56 in FIG. 11), for instance 2-10 ms after the inner pipe has reached its to position.

As is shown in FIGS. 14e and 14f the working fluid spaces 65 and 66 may be connected to further fluid lines 68 and 69 to make upward movement (FIG. 14e) and downward movement (FIG. 140 of the piston 62 and therewith the inner pipe with respect to the outer pipe possible in the fixation state of the fixation device.

In the above described method the inner pipe is gripped at the beginning of an upward movement of the inner pipe. This is desirable as at that moment the speed of the inner pipe is zero or at least relatively low. The inner pipe may also be gripped during the upward movement. During this gripping of the inner pipe with the inner pipe gripping device the gripping may have some slip, as the gripping step with the inner pipe gripping device is not critical for the fixation of the inner pipe. Gripping of the inner pipe during the upper movement may for instance be desirable when the oscillations of the inner pipe are larger than the maximum stroke of the jacks 24. By gripping during the upward stroke, the distance from the moment of gripping to the top blocking position may be chosen such that this distance is smaller than the maximum stroke of the jacks 24.

In an alternative embodiment, the jacks 24 may be mounted upside down, or in any other suitable position and any type of suitable jacks 24 may be used.

Further, the non-return valve 67 may as in an alternative embodiment be arranged to block fluid flow out of the working fluid space 65. In such embodiment the inner pipe should be gripped at the beginning of during a downward movement of the piston and the piston will blocked in a lower position.

1. A fixation device for fixation of a position of an inner pipe of a double-walled pipe with respect to a pipe laying structure and/or an outer pipe of said double-walled pipe, said fixation device comprising:
an inner pipe gripping device configured to grip said inner pipe, and
a connection device configured to connect said inner pipe gripping device with said pipe laying structure and/or said outer pipe, said connection device having a flexible state in which, during use, the inner pipe gripping device is movable with respect to said pipe laying structure and/or said outer pipe, and a fixation state in which, during use, the inner pipe gripping device is fixated with respect to the pipe-laying structure and/or said outer pipe.

2. The fixation device of claim 1, wherein said fixation device comprises an actuation element to switch the connection device between said flexible state and said fixation state.

3. The fixation device of claim 1, wherein said fixation device is configured to automatically switch from said flexible state to said fixation state in a desired position of said inner pipe.

4. The fixation device of claim 1, wherein said fixation device comprises an outer pipe gripping device configured to grip said outer pipe, the connection device being connected to said outer pipe gripping device.

5. The fixation device of claim 1, wherein said connection device is connected to a J-lay tower.

6. The fixation device of claim 1, wherein said connection device comprises one or more hydraulic or pneumatic piston-cylinder assemblies.

7. The fixation device of claim 1, wherein said connection device comprises one or more hydraulic piston-cylinder assemblies, each having a first working fluid space, said first working fluid space having a working fluid port in fluid communication with a non-return valve.

8. The fixation device of claim 7, wherein each piston-cylinder assembly comprises a second working fluid space at a opposite side of said piston with respect to said first working fluid space, said second working fluid space and said first working fluid space being in fluid communication via a fluid line comprising said non-return valve.

9. The fixation device of claim 8, wherein in said fluid line between said first and second working fluid spaces further comprises an active valve, having a first valve position in which the fluid line is open and a second valve position in which said fluid line is closed.

10. The fixation device of claim 6, wherein at least one of said one or more piston cylinder assemblies comprises a first and a second working fluid space at opposite sides of said piston, which first and second working fluid spaces are in fluid communication with each other during the flexible state and are closed with respect to each other during the fixation state.

11. The fixation device of claims 2 and 10, wherein said fixation device comprises an actuation element to switch the connection device between said flexible state and said fixation state, and wherein said actuation element is a valve which is provided in a fluid connection between said first and second working fluid spaces, and allows switching between the flexible state and the fixation state by opening and closing of the valve respectively.

12. The fixation device of claim 1, wherein said fixation device comprises a sensor device configured to determine the position of said inner pipe with respect to said pipe laying structure and/or said outer pipe.

13. The fixation device of claim 1, wherein said connection device is hingedly connected to said pipe-laying structure and/or said outer pipe.

14. The fixation device of claim 1, wherein said connection device is hingedly connected to said inner pipe gripping device and to said outer pipe gripping device.

15. The fixation device of claim 1, wherein said inner pipe gripping device is substantially ring shaped and comprises two semi-ring shaped parts.

16. The fixation device of claim 1, wherein said inner pipe gripping device is a clamping device.

17. The fixation device of claim 16, wherein said clamping device comprises a number of friction elements to be pressed against the outer surface of said inner pipe during clamping.

18. A pipe-laying structure comprising the fixation device of claim 1.

19. The pipe-laying structure of claim 18, wherein said pipe laying structure comprises a J-lay tower.

20. A pipe laying vessel comprising the fixation device of claim 1.

21. A method to fixate an inner pipe of a double-walled pipe with respect to the outer pipe thereof, said method comprising the steps of:
gripping said outer pipe with an outer pipe gripping device,
determining the position of said inner pipe with respect to said outer pipe,
gripping said inner pipe with an inner pipe gripping device, said inner pipe gripping device being connected with said outer pipe gripping device via a connection device, said connection device having a flexible state in which movement between the inner pipe gripping device and the outer pipe is possible and a fixation state in which the inner pipe gripping device is fixated with respect to said outer pipe, said connection device being in the flexible state, and
fixating said inner pipe with respect to said outer pipe by bringing the connection device in the fixation state.

22. A method to fixate an inner pipe of a double-walled pipe with respect to a pipe laying structure, said method comprising the steps of:
determining the position of said inner pipe with respect to said pipe laying structure
gripping said inner pipe with an inner pipe gripping device, said inner pipe gripping device being connected with said pipe laying structure via a connection device, said connection device having a flexible state in which movement between the inner pipe gripping device and the pipe laying structure is possible and a fixation state in which the inner pipe gripping device is fixated with respect to the pipe laying structure, said connection device being in the flexible state,
and
fixating said inner pipe with respect to said pipe laying structure by bringing the connection device in the fixation state.
